(19) United States
(12) Patent Application Publication
(10) Pub. No.: US 2004/0112296 A1
(43) Pub. Date: Jun. 17, 2004

(54) Bird feeder apparatus

(76) Inventor: Randall G. Arthurs, Rockford, IL (US)

Correspondence Address: DAVID J. ARCHER, 9790 FOREST PRESERVE RD., DURAND, IL, 61024, US

(21) Appl. No.: 10/396,609

(22) Filed: Mar. 25, 2003

Related U.S. Application Data
(60) Provisional application No. 60/432,742, filed on Dec. 13, 2002.

(51) Int. Cl. A01K 61/02

(52) U.S. Cl. 119/52.2

(57) ABSTRACT

A bird feeder apparatus is disclosed for supplying bird seed to a bird feeder. The apparatus includes a receptacle which defines an enclosure for storing the bird seed therein. The receptacle has an opening for the reception therethrough of the bird seed, the opening always being open to atmospheric pressure. The receptacle also defines an outlet which is disposed remote from the opening for permitting a flow therethrough of the bird seed from the enclosure to the bird feeder. A blower is connected to the outlet of the receptacle such that when the blower is activated, an air stream is blown from the blower through a venturi device then across the outlet inducing the bird seed from the outlet and into the air stream and then blowing the seed to the bird feeder.

### CROSS REFERENCE TO RELATED APPLICATIONS

The present application is a Complete application to Provisional Patent Application U.S. Ser. No. 60/432,742 filed Dec. 13th 2002. All of the disclosure of the aforementioned Provisional application is incorporated herein by reference.

### BACKGROUND OF THE INVENTION

1. Field of the Invention

The present invention relates to a bird feeder apparatus for supplying bird seed to a bird feeder. More specifically, the present invention relates to a bird feeder apparatus for automatically supplying bird seed to a bird feeder.

2. Background Information

Bird feeders are provided in backyards and on decks for feeding wild birds. However, such bird feeders require regular filling with fresh bird seed. Filling of such bird feeders typically entails taking a supply of seed into the yard and lifting a lid of the bird feeder in order to pour a new supply of the seed into the bird feeder. Although the above is a relatively easy procedure in summer months, such regular replenishment of the seed in time becomes an unwelcome chore. This is particularly so during winter months.

Furthermore, during absence due to a vacation or a business trip, it becomes essential for a neighbor or friend to take responsibility for attending to the regular bird seed filling operation.

Accordingly, attempts have been made to provide automatic bird seed filling arrangements which will replenish seed automatically from a fresh supply. An automatic arrangement is disclosed in U.S. Pat. No. 5,749,316 to Deagan. However, the automatic self-filling bird feeder of Deagan requires filling a bird seed receptacle and sealing the same in an air tight manner so that when a blower is actuated, the receptacle is pressurized. The seed is then forced through a supply conduit to a bird feeder. As shown in FIG. 2 of the Deagan Patent, because of the need for pressurizing the receptacle, a relatively small opening 33 is provided for filling the receptacle 12 with seed. Also, after filling, an air tight cap 34 must be secured so that the whole of the enclosure of the receptacle 12 can be pressurized when the blower is energized. Moreover, the Deagan Patent arrangement would require a more powerful blower as the size of the seed container increases and the larger more powerful blower would take up more room in the seed container. Such would limit the practical seed storage capacity.

The present invention greatly simplifies the automatic feeding of bird seed to a bird feeder by the provision of a non pressurized seed receptacle which is always open to atmospheric pressure. Such an arrangement according to the present invention permits the provision of a relatively large opening in the seed receptacle which facilitates and speeds up the process of filling the seed receptacle with replacement bird seed.

Also, according to the present invention, a bird feeder apparatus includes a blower which when energized, generates a venturi effect which causes a vacuum which induces seed from the seed receptacle into the air stream for then blowing the bird seed through a supply conduit to the bird feeder.

Additionally, according to the present invention, a bird feeder apparatus includes a bird feeder which by design inhibits flow of seed thereto when a sufficient supply of seed has been fed to the bird feeder thus eliminating the need to have a level sensing device and associated wiring.

Therefore, a primary feature of the present invention is the provision of a bird feeder apparatus that includes a blower which generates a venturi effect for creating a vacuum for inducing seed into the air stream which delivers it to the bird feeder.

Another feature of the present invention is the provision of a bird feeder apparatus that has a seed receptacle that is not limited in size. The seed receptacle can be any size such as 50 lb, 100 lb, 200 lb or more without increasing the blower size or compromising performance and which easily handles small and large or mixed seed.

A further feature of the present invention is the provision of a bird feeder apparatus that includes a relatively large opening for filling a receptacle with seed and which does not have to be airtight.

Yet another feature of the present invention is the provision of a bird feeder apparatus that includes a seed receptacle which is open to atmospheric pressure and which is easier to construct and maintain and which is less costly.

Another feature of the present invention is the provision of a bird feeder apparatus which during a bird feeder fill cycle, the air stream coming out of the bird feeder tends to clear the bird feeder of winter snow, making it more accessible to birds.

Also, another feature of the present invention is the provision of a bird feeder apparatus that overcomes the problems associated with the prior art arrangements.

Other features and advantages of the present invention will be readily apparent to those skilled in the art by a consideration of the detailed description of a preferred embodiment of the present invention contained herein.

### SUMMARY OF THE INVENTION

The present invention relates to a bird feeder apparatus for supplying bird seed to a bird feeder. The apparatus includes a receptacle which defines an enclosure for storing the bird seed therein. The receptacle has an opening for the reception therein of the bird seed and the opening is always open to atmospheric pressure. The receptacle also defines an outlet which is disposed remote from the opening for permitting a flow therethrough of the bird seed from the enclosure to the bird feeder. A blower is connected to the outlet of the receptacle and is selectively connected to a source of power. A venturi device is located adjacent to the outlet such that when the blower is activated, an air stream is blown from the blower through the venturi device which creates a vacuum across the outlet for inducing the bird seed from the outlet to the air stream and then blowing the seed into the bird feeder.

In a more specific embodiment of the present invention, the receptacle includes a base which is of inverted conical configuration such that when the receptacle is filled with the bird seed and the bird seed is supplied to the bird feeder, the bird seed flows in a direction from the opening towards the conical base and through the outlet.

Also, the base is of truncated conical configuration, the truncated configuration of the base defining the outlet.

Furthermore, the inverted conical base is of regular conical configuration and a pipe extends from the outlet. The pipe has a first and a second end, the first end of the pipe being sealingly connected to the outlet. Also, the pipe is offset relative to a longitudinal axis of the conical base.

In a preferred arrangement of the present invention, the pipe and venturi device are of T-shaped configuration.

The apparatus further includes a container for the reception therein of the seed receptacle. A removable cover cooperates with the container for protecting the seed receptacle and the bird seed disposed therein from the elements and from the ingress therein of wildlife and insects.

Preferably, the removable cover includes a handle for assisting removal of the cover from the container.

Moreover, the blower is housed within the container and disposed outside the seed receptacle.

Additionally, a screened vent is provided for permitting air to flow into the container when the cover is covering the container so that entry of wildlife and insects into the container when covered is inhibited while permitting air to flow into the blower when the blower is energized.

In a preferred embodiment of the present invention, the screened vent is disposed between the container and the cover for permitting air to flow into the container when the cover is covering the container so that entry of the wildlife and insects into the container when covered is inhibited while permitting air to flow into the blower when the blower is energized.

Furthermore, the blower includes an air inlet and an air outlet, the air outlet being connected to the second end of the pipe.

The air outlet and the second end of the pipe define a juncture, the air outlet and the second end of the pipe being joined angularly relative to each other such that when the blower is energized, air flowing from the inlet through the air outlet generates a venturi effect and vacuum in a vicinity of the second end of the pipe to induce the bird seed from the second end of the pipe into the air stream and then blowing the seed towards the bird feeder.

Moreover, the air outlet defines a venturi which is disposed between the air outlet and the second end of the pipe for increasing air velocity creating a venturi effect and vacuum inducing seed from the seed receptacle into the air stream and blowing it to the bird feeder.

A conduit has a first and a second extremity, the first extremity of the conduit being connected to the juncture and the second extremity being connected to the bird feeder.

The bird feeder includes a tube which has a first and a second termination. The second extremity of the conduit is disposed within the tube.

Also, a screen cover is secured to the first termination of the tube so that when the blower is energized, the bird seed flows from the first extremity of the conduit to the second extremity thereof and into the tube. The screen cover prevents flow therethrough of the bird seed while permitting the flow therethrough of air so that the bird seed fills the tube from the first towards the second termination thereof.

Additionally, the bird feeder includes a floor which is disposed adjacent to and spaced relative to the second termination of the tube. The arrangement is such that the bird seed fed to the second termination of the tube is supported on the floor for permitting feeding by a bird disposed adjacent to the floor.

Moreover, the bird feeder includes a first and a second wall spaced relative to each other and extending from the floor. The second extremity of the conduit and the tube are disposed between the walls. A rod extends through the first wall and the tube between the first and second terminations thereof and through the second wall for supporting the second termination of the tube in spaced relationship relative to the floor.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a side elevational view of a bird feeder apparatus according to the present invention for supplying bird seed to a bird feeder;

FIG. 2 is a sectional view taken on the line 2-2 of FIG. 1;

FIG. 3 is a similar view to that shown in FIG. 1 but shows an alternative embodiment of the present invention; and

FIG. 4 is a similar view to that shown in FIG. 1 but shows another alternative embodiment of the present invention.

Similar reference characters refer to similar parts throughout the various views of the drawings.

### DETAILED DESCRIPTION OF THE DRAWINGS

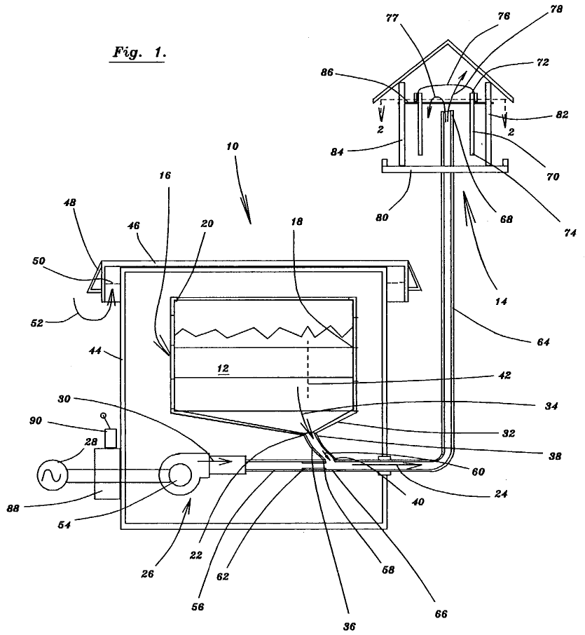

FIG. 1 is a side elevational view of a bird feeder apparatus generally designated 10 according to the present invention for supplying bird seed 12 to a bird feeder generally designated 14. The apparatus 10 includes a receptacle generally designated 16 which defines an enclosure 18 for storing the bird seed 12 therein. The receptacle 16 has an opening 20 for the reception therein of the bird seed 12, the opening 20 always being open to atmospheric pressure. The receptacle 16 also defines an outlet 22 which is disposed remote from the opening 20 for permitting a flow therethrough as indicated by the arrow 24 of the bird seed 12 from the enclosure 18 to the bird feeder 14. A blower generally designated 26 is connected to the outlet 22 of the receptacle 16. The blower 26 is selectively connected to a source of power 28. Also, a venturi device 62 is disposed adjacent to the outlet 22 such that when the blower 26 is energized, an air stream as indicated by the arrow 30 is blown from the blower 26 through the venturi device 62 then across the outlet 22 for inducing the bird seed 12 from the outlet 22 and into the air stream 30 then blowing the seed to the bird feeder 14.

In a more specific embodiment of the present invention, the receptacle 16 includes a base 32 which is of inverted conical configuration such that when the receptacle 16 is filled with the bird seed 12 and the bird seed 12 is supplied to the bird feeder 14, the bird seed 12 flows in a direction as indicated by the arrow 34 from the opening 20 towards the conical base 32 and through the outlet 22.

Also, the base 32 is of truncated conical configuration, the truncated configuration of the base 32 defining the outlet 22.

Furthermore, the inverted conical base 32 is of regular conical configuration and a pipe 36 extends from the outlet 22. The pipe 36 has a first and a second end 38 and 40 respectively, the first end 38 of the pipe 36 being sealingly connected to the outlet 22. Also, the pipe 36 is offset relative to a longitudinal axis 42 of the conical base 32. More specifically, the pipe and venturi device are a special T-shaped fitting.

The apparatus 10 further includes a container 44 for the reception therein of the receptacle 16. A removable cover 46 cooperates with the container 44 for protecting the receptacle 16 and the bird seed 12 disposed therein from the elements and from the ingress therein of wildlife and insects.

Preferably, the removable cover 46 includes a handle 48 or handles for assisting removal of the cover 46 from the container 44.

Moreover, the blower 26 is housed within the container 44 and outside the receptacle 16.

Additionally, a screened vent 50 is provided for permitting air to flow into the container 44 as indicated by the arrow 52 when the cover 46 is covering the container 44 so that entry of wildlife and insects into the container 44 when covered is inhibited while permitting air to flow as indicated by the arrow 30 from the blower 26 when the blower 26 is energized.

In a preferred embodiment of the present invention, the screened vent 50 is disposed between the container 44 and the cover 46 for permitting air to flow into the container as indicated by the arrow 52 when the cover 46 is covering the container 44 so that entry of wildlife and insects into the container 44 when covered is inhibited while permitting air to flow from the blower as indicated by the arrow 30 when the blower 26 is energized.

Furthermore, the blower 26 includes an air inlet 54 and an air outlet 56, the air outlet 56 being connected to the second end 40 of the pipe 36.

The air outlet 56 and the second end 40 of the pipe 36 define a juncture 58, the air outlet 56 and the second end 40 of the pipe 36 being joined angularly relative to each other to form a special T-shaped fitting as shown. The arrangement is such that when the blower 26 is energized, air flowing, as indicated by arrow 30, from the air inlet 54 through the air outlet 56 and through the venturi device 62 generates a venturi effect and vacuum as indicated by the arrow 60 in a vicinity of the second end 40 of the pipe 36 for inducing the bird seed 12 from the second end 40 of the pipe 36 and into the air stream 30 and blowing the seed towards the bird feeder 14.

Moreover, the air outlet 56 includes the venturi device 62 which is disposed between the air inlet 54 and the second end 40 of the pipe 36 for increasing the velocity of the air flow creating a venturi effect and vacuum at 60 inducing the bird seed 12 from the enclosure 18 into the air stream and then to the bird feeder 14

A conduit 64 has a first and a second extremity 66 and 68 respectively. The first extremity 66 of the conduit 64 is connected to the juncture 58 and the second extremity 68 is connected to the bird feeder 14.

The bird feeder 14 includes a tube 70 which has a first and a second termination 72 and 74 respectively. The second extremity 68 of the conduit 64 is disposed within the tube 70.

Also, a screen cover 76 is secured to the first termination 72 of the tube 70 so that when the blower 26 is energized, the bird seed flows as indicated by the arrow 60 from the first extremity 66 of the conduit 64 to the second extremity 68 thereof and into the tube 70. The screen cover 76 prevents flow therethrough of the bird seed 12 as indicated by the arrow 77 while permitting the flow therethrough of air as indicated by the arrow 78 so that the bird seed 12 fills the tube 70 from the first termination 72 towards the second termination 74 thereof.

Additionally, the bird feeder 14 includes a floor 80 which is disposed adjacent to and spaced relative to the second termination 74 of the tube 70. The arrangement is such that the bird seed 12 fed to the second termination 74 of the tube 70 is supported on the floor 80 for permitting feeding by a bird disposed adjacent to the floor 80.

Moreover, the bird feeder 14 includes a first and a second wall 82 and 84 respectively spaced relative to each other and extending from the floor 80. The second extremity 68 of the conduit 64 and the tube 70 are disposed between the walls 82 and 84. A rod 86 extends through the first wall 82 and the tube 70 between the first and second terminations 72 and 74 respectively thereof and through the second wall 84 for supporting the second termination 74 of the tube 70 in spaced relationship relative to the floor 80.

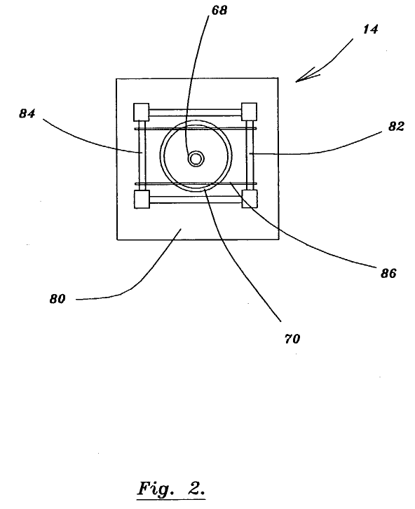

FIG. 2 is a sectional view taken on the line 2-2 of FIG. 1. As shown in FIG. 2, the tube 70 which is preferably fabricated from translucent material is supported by at least one rod 86. Also, the second extremity 68 of the conduit 64 is disposed concentrically within the tube 70.

As shown in FIG. 1, an actuator 88 is disposed adjacent to the blower 26. The actuator 88 includes a manual switch 90 for selectively connecting the blower 26 to the source of electrical power 28. The source of power 28 can be a mains outlet or alternatively, an electrical storage battery. Also, those skilled in the art will appreciate that the venturi effect flow 60 could be provided by compressed air supplied from an air compressor or the like in place of the blower. Also, a wide variety of existing bird feeders could be adapted to the bird feeder apparatus according to the present invention thus making them self filling.

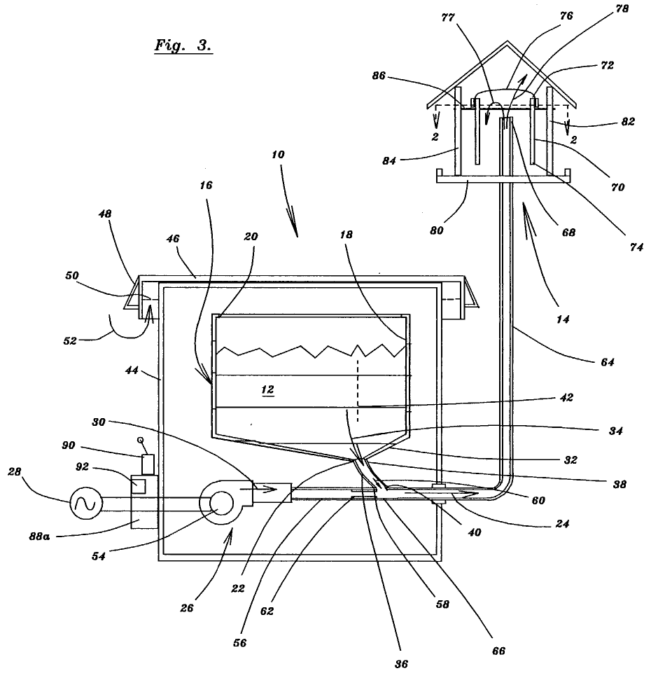

FIG. 3 is a similar view to that shown in FIG. 1 but shows an alternative embodiment of the present invention. As shown in FIG. 3, the actuator 88a includes a timer 92 so that the blower 26a is automatically switched on and off preferably at night for replenishing the seed at the bird feeder. Such energizing of the blower 26 at night avoids frightening birds that normally will feed during daylight hours.

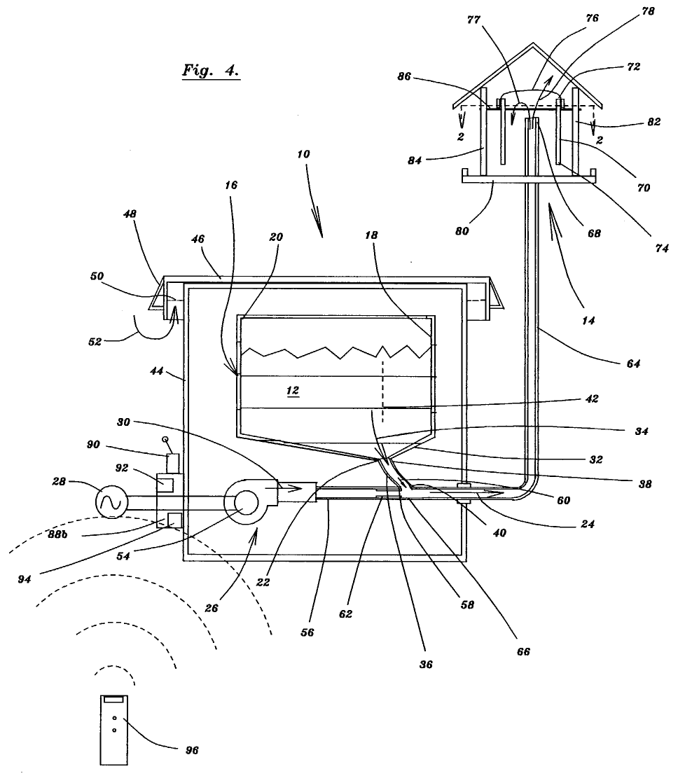

FIG. 4 is a similar view to that shown in FIG. 1 but shows another alternative embodiment of the present invention. As shown in FIG. 4, the actuator 88b includes a receiver 94 for receiving a signal from a remote controller 96. However, those skilled in the art will appreciate that the actuator could include a remote controller and receiver, a timer and a manual switch or a combination of these elements. Furthermore, although the apparatus 10 is shown as an integral unit, it will be appreciated by those skilled in the art that the container 44 and contents could be located within a dwelling or on a deck and the bird feeder 14 located in a yard with the bird feeder 14 connected to the container 44 by the conduit 64.

In operation of the apparatus 10 according to the present invention, the cover 46 is removed so that the receptacle 16 can be filled with seed via the opening 20. The cover 46 is replaced and the blower 26 is energized by the manual switch 90, the timer device 92 or the remote controller 96. When the blower 26 is activated, seed 12 is induced by the venturi effect 60 through the pipe 36 then blown through the conduit 64. Seed 12 is guided by the screen cover 76 so that the seed fills the tube 70 while air flows from the conduit 64 through the screen cover 76 as indicated by the arrow 78. Therefore, as seed 12 fills the tube 70, such seed becomes available on the floor 80 of the bird table 14 so that birds can feed therefrom. When the blower 26 is switched off, the air flow and seed within the conduit 64 settles down within the conduit 64 until the next activation of the blower 26.

If the blower is allowed to run after the bird feeding table is full then the seed will be pushed all the way to the top of the tube 70 until they block the screen cover 76 at which time air flow will be dramatically reduced. This causes the venturi action and the induction process at 60 to stop and the seed 12 will not be delivered through conduit 64.

Those skilled in the art will appreciate that the “fill” timers “on” duration is not critical since it is physically incapable of overfilling the bird feeder by design. This alleviates the need for a level sensing device with wiring to the blower thereby reducing the cost and improving reliability.

The present invention provides a unique means for automatically filling a bird feeder.

What is claimed is:

1. A bird feeder apparatus for supplying bird seed to a bird feeder, said apparatus comprising:
a receptacle defining an enclosure for storing the bird seed therein, said receptacle having an opening for the reception therethrough of the bird seed, said opening always being open to atmospheric pressure, said receptacle defining an outlet which is disposed remote from said opening for permitting a flow therethrough of the bird seed from said enclosure to the bird feeder;
a venturi device connected to said outlet; and
a blower operably connected to said venturi device such that when said blower is activated, an air stream is blown from said blower through said venturi device across said outlet inducing the bird seed from said outlet into said air stream then blowing the seed to the bird feeder.

2. A bird feeder apparatus as set forth in claim 1 wherein
said receptacle includes:
a base which is of inverted conical configuration such that when said receptacle is filled with the bird seed and the bird seed is supplied to the bird feeder, the bird seed flows in a direction from said opening towards said conical base and through said outlet.

3. A bird feeder apparatus as set forth in claim 2 wherein
said base is of truncated configuration, said truncated configuration of said base defining said outlet.

4. A bird feeder apparatus as set forth in claim 3 wherein
said inverted conical base is of regular conical configuration;
a pipe extending from said outlet, said pipe having a first and a second end, said first end of said pipe being sealingly connected to said outlet, said pipe being offset relative to a longitudinal axis of said conical base.

5. A bird feeder apparatus as set forth in claim 1 wherein
said apparatus further includes:
a container for the reception therein of said receptacle;
a removable cover cooperating with said container for protecting said receptacle and the bird seed disposed therein from the elements and from the ingress therein of wildlife and insects.

6. A bird feeder apparatus as set forth in claim 5 wherein
said removable cover includes:
a handle for assisting removal of said cover from said container.

7. A bird feeder apparatus as set forth in claim 5 wherein
said blower is housed within said container and disposed outside said receptacle.

8. A bird feeder apparatus as set forth in claim 5 wherein
said blower associated with said outlet of said receptacle is an electric blower, said blower being selectively connected to a source of power such that when said blower is energized, a current of air is blown from said blower through said venturi device and across said outlet inducing the bird seed from said outlet into said air stream then to the bird feeder.

9. A bird feeder apparatus as set forth in claim 8 further including:
a screened vent for permitting air to flow into said container when said cover is covering said container so that entry of the wildlife and insects into said container when covered is inhibited while permitting air to flow into said blower when said blower is energized.

10. A bird feeder apparatus as set forth in claim 8 further including:
a screened vent disposed between said container and said cover for permitting air to flow into said container when said cover is covering said container so that entry of the wildlife and insects into said container when covered is inhibited while permitting air to flow into said blower when said blower is energized.

11. A bird feeder apparatus as set forth in claim 4 wherein
said blower includes:
an air inlet;
an air outlet, said air outlet being connected to said venturi device which is connected to said second end of said pipe.

12. A bird feeder apparatus as set forth in claim 11 wherein
said air outlet of said venturi device and said second end of said pipe define a juncture, said air outlet of said venturi device and said second end of said pipe being joined angularly relative to each other such that when said blower is activated, said air stream flowing from said inlet through said venturi device generates a venturi effect and vacuum in a vicinity of said second end of said pipe for inducing the bird seed into said second end of said pipe and into said air stream and then towards the bird feeder.

13. A bird feeder apparatus as set forth in claim 12 wherein
said air outlet includes said venturi device which is disposed between said air inlet and said second end of said pipe for increasing a velocity of said air stream therethrough creating a venturi effect and vacuum for inducing the bird seed from said enclosure into said air stream and then to the bird feeder.

14. A bird feeder apparatus as set forth in claim 12 further including:
a conduit having a first and a second extremity, said first extremity of said conduit being connected to said juncture, said second extremity being connected to the bird feeder.

15. A bird feeder apparatus as set forth in claim 14 wherein
the bird feeder includes:
a tube having a first and a second termination, said second extremity of said conduit being disposed within said tube.

16. A bird feeder apparatus as set forth in claim 15 further including:
a screen cover secured to said first termination of said tube so that when said blower is energized, the bird seed flows from said first extremity of said conduit to said second extremity thereof and into said tube, said screen cover preventing flow therethrough of the bird seed while permitting the flow therethrough of air so that the bird seed fills said tube from said first towards said second termination thereof.

17. A bird feeder apparatus as set forth in claim 16 wherein
the bird feeder includes:
a floor disposed adjacent to and spaced relative to said second termination of said tube such that the bird seed fed to said second termination of said tube is supported on said floor for permitting feeding by a bird disposed adjacent to said floor.

18. A bird feeder apparatus as set forth in claim 17 wherein
the bird feeder includes:
a first and a second wall spaced relative to each other and extending from said floor, said second extremity of said conduit and said tube being disposed between said walls;
a rod extending through said first wall and said tube between said first and second terminations thereof and through said second wall for supporting said second termination of said tube in spaced relationship relative to said floor.

19. A bird feeder apparatus for supplying bird seed to a bird feeder, said apparatus comprising:
a receptacle defining an enclosure for storing the bird seed therein, said receptacle having an opening for the reception therethrough of the bird seed, said opening always being open to atmospheric pressure, said receptacle defining an outlet which is disposed remote from said opening for permitting a flow therethrough of the bird seed from said enclosure to the bird feeder;
a venturi device connected to said outlet; and
an electric blower connected to said venturi device, said blower being selectively connected to a source of electrical power such that when said blower is energized, an air stream is blown from said blower through said venturi device then across said outlet inducing the bird seed from said outlet to the bird feeder.

20. A bird feeder apparatus for supplying bird seed to a bird feeder, said apparatus comprising:
a receptacle defining an enclosure for storing the bird seed therein, said receptacle having an opening for the reception therethrough of the bird seed, said opening always being open to atmospheric pressure, said receptacle defining an outlet which is disposed remote from said opening for permitting a flow therethrough of the bird seed from said enclosure to the bird feeder;
an electric blower associated with said outlet of said receptacle, said blower being selectively connected to a source of electrical power such that when said blower is energized, a current of air is blown from said blower across said outlet for conveying the bird seed from said outlet to the bird feeder; and
an actuator for automatically energizing said blower so that the bird feeder is automatically replenished with bird seed.
